(19) United States
(12) Patent Application Publication
(10) Pub. No.: US 2022/0405055 A1
(43) Pub. Date: Dec. 22, 2022

(54) ARITHMETIC DEVICE

(71) Applicant: FUJITSU LIMITED, Kawasaki-shi (JP)

(72) Inventor: Tetsutaro HASHIMOTO, Kawasaki (JP)

(73) Assignee: FUJITSU LIMITED, Kawasaki-shi (JP)

(21) Appl. No.: 17/690,043

(22) Filed: Mar. 9, 2022

(30) Foreign Application Priority Data
Jun. 17, 2021 (JP) 2021-100783

(51) Int. Cl. G06F 7/544; G06F 7/483

(52) U.S. Cl. CPC G06F 7/5443; G06F 7/483

(57) ABSTRACT

An arithmetic device according to an embodiment includes a first operation unit that calculates a shared exponent bias value for shifting a dynamic range of a floating-point operation; a second operation unit that calculates a sum-of-product arithmetic result of a second number of bits larger than a first number of bits by performing arithmetic operations corresponding to a large number of elements on a first data set formed of a shared exponent bias value and an activation value of a floating point of the first number of bits, and a second data set formed of a shared exponent bias value and a weight of a floating point of the first number of bits; and a quantizer that updates the activation value by quantizing the number of bits of the sum-of-product arithmetic result from the second number of bits to the first number of bits.

### CROSS-REFERENCE TO RELATED APPLICATION(S)

This application is based upon and claims the benefit of priority of the prior Japanese Patent Application No. 2021-100783, filed on Jun. 17, 2021, the entire contents of which are incorporated herein by reference.

### FIELD

The embodiments discussed herein are related to an arithmetic device.

### BACKGROUND

A recognition rate of a Deep Neural Network (DNN) has been improved by enlarging the scale of the DNN and increasing the depth thereof. However, an operation amount of the DNN is increased by the enlarged scale and the increased depth thereof, and a training time of the DNN is increased in proportion to the increase in the operation amount.

To shorten the training time of the DNN, a Low Precision Operation (LPO) of 8-bit floating point (FP8) or 16-bit floating point (FP16) is used for training of the DNN in some cases. For example, when the arithmetic operation of FP8 is used, parallelism of a Single Instruction Multiple Data (SIMD) arithmetic operation can be caused to be four times the arithmetic operation of 32-bit floating point (FP32), so that the operation time can be shortened to be ¼. In contrast to the LPO of FP8 or FP16, the arithmetic operation of FP32 is called Full Precision Operation (FPO) in some cases. For example, as in a case of changing FP32 to FP8, changing the arithmetic operation of the DNN from the FPO to the LPO by reducing the number of bits of data is called quantization in some cases. Additionally, the arithmetic operation of the DNN including both of the FPO and the LPO is called Mixed Precision Operation (MPO) in some cases. Training of the DNN using the MPO (Mixed Precision Training) (MPT), the FPO is performed for a layer in which the recognition rate is lowered by quantization, so that a layer for which the LPO is performed and a layer for which the FPO is performed are both present in a mixed manner. Conventional technologies are described in U.S. Laid-open Patent Publication No. 2020/0234112, U.S. Laid-open Patent Publication No. 2019/0042944, U.S. Laid-open Patent Publication No. 2020/0042287, U.S. Laid-open Patent Publication No. 2020/0134475, U.S. Laid-open Patent Publication No. 2020/0242474, and U.S. Laid-open Patent Publication No. 2018/0322607, for example.

A center of a dynamic range of a floating-point operation is 0, but a value of the DNN does not fall within a range covered by the dynamic range. Accordingly, when the floating-point operation is used for training of the DNN, the recognition rate of the DNN is lowered. Thus, for preventing the recognition rate of the DNN from being lowered, it can be considered to perform an arithmetic operation for shifting the dynamic range of the floating-point operation by a shared exponent bias value (hereinafter, referred to as a “Flexible Floating-point Operation (FFPO)” in some cases) in a range in which a maximum value in distribution of values of the DNN falls within the dynamic range of the floating-point operation.

However, there is no arithmetic device that can perform the FFPO at the time of performing the MPO, so that it has been difficult to increase speed of training of the DNN.

### SUMMARY

According to an aspect of an embodiment, an arithmetic device includes a first operation unit that calculates a shared exponent bias value for shifting a dynamic range of a floating-point operation; a second operation unit that calculates a sum-of-product arithmetic result of a second number of bits larger than a first number of bits by performing sum-of-product arithmetic operations corresponding to a large number of elements on a first data set formed of a shared exponent bias value and an activation value of a floating point of the first number of bits, and a second data set formed of a shared exponent bias value and a weight of a floating point of the first number of bits; and a quantizer that updates the activation value by quantizing the number of bits of the sum-of-product arithmetic result from the second number of bits to the first number of bits.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration example of a DNN training device according to a first embodiment;

FIG. 2 is a diagram illustrating a configuration example of a SIMD arithmetic unit according to the first embodiment;

FIG. 3A is a diagram illustrating an example of a pseudo-code of a DOT4 command according to the first embodiment;

FIG. 3B is a diagram illustrating an example of a pseudo-code of a DOT4 command according to the first embodiment;

FIG. 4 is a diagram illustrating an example of an internal diagram of a DOT4 arithmetic unit according to the first embodiment;

FIG. 5 is a flowchart illustrating an example of a processing procedure performed by an arithmetic device according to the first embodiment;

FIG. 6 is a diagram illustrating an example of a data flow in a DNN training device according to the first embodiment;

FIG. 7 is a diagram illustrating an example of a hardware configuration of a SIMD arithmetic unit according to the first embodiment; and

FIG. 8 is a diagram illustrating an example of an internal diagram of a DOT4 arithmetic unit according to a second embodiment.

### DESCRIPTION OF EMBODIMENT(S)

Preferred embodiments of the present invention will be explained with reference to accompanying drawings. In the following description, the same configurations are denoted by the same reference numeral, and redundant description about the same configuration or the same processing will not be repeated. The following embodiments do not limit the technique disclosed herein.

### [a] First Embodiment

Configuration of DNN Training Device

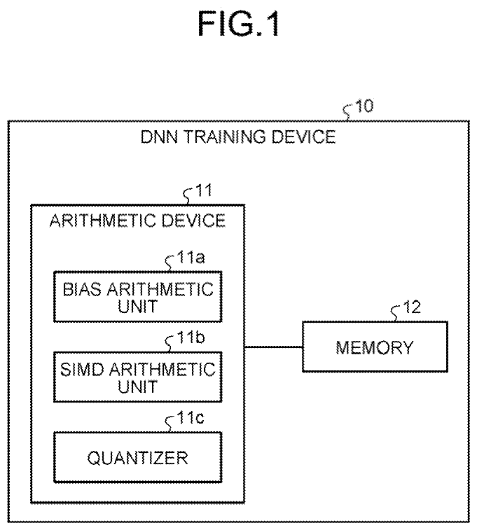

FIG. 1 is a block diagram illustrating a configuration example of a DNN training device according to a first embodiment. For example, as a DNN training device 10, an information processing device such as various kinds of computers can be employed.

In FIG. 1, the DNN training device 10 performs arithmetic processing at the time of training of the DNN. The DNN training device 10 includes an arithmetic device 11 and a memory 12. The arithmetic device 11 includes a bias arithmetic unit 11a, a SIMD arithmetic unit 11b, and a quantizer 11c.

Herein, a value of a floating-point operation is given by the expression (1). In the expression (1), s is a 1-bit fixed sign bit, N_{ebit} is the number of bits of an exponent portion e, and N_{mbit} is the number of bits of a mantissa portion m. For example, in a case of FP32, N_{ebit}=8 and N_{mbit}=23 are satisfied.

$$value = {( - 1 )}^{s} ( 1 + {{\sum }_{i = 1}}^{{N}_{mbit}} {m}_{- i} {2}^{- i} ) \times {2}^{e - ( {2}^{N} {ebit}^{- 1} - 1 )} \qquad ( 1 )$$

In a case in which denormalized data is not included in input data, a value of FFPO at the time of applying a shared exponent bias value b to the expression (1) is given by the expressions (2) and (3). That is, the expression (2) is an expression in a case in which the value is a normalized number. The shared exponent bias value b is a common single value in units of quantization.

$$value = {( - 1 )}^{s} ( 1 + {{\sum }_{i = 1}}^{{N}_{mbit}} {m}_{- i} {2}^{- i} ) \times {2}^{e - ( {2}^{N} {ebit}^{- 1} - 1 ) + b} \qquad ( 2 )$$

$$- 126 \leq e - ( {2}^{{N}_{ebit} - 1} - 1 ) + b \leq 127 \qquad ( 3 )$$

The shared exponent bias value b is given by the expression (4), and shifts a dynamic range of the floating-point operation represented by the expression (1). In the expression (4), eₘₐₓ is an exponent item of fₘₐₓ in the expression (5), and f in the expression (5) is all elements to be quantized.

$$b = {e}_{max} - {2}^{{N}_{{ebit}^{- 1}}} - 126 \qquad ( 4 )$$

$${f}_{max} = {max}_{∀ f ∈ F} \vert f \vert \qquad ( 5 )$$

The bias arithmetic unit 11a calculates the shared exponent bias value b of 8-bit fixed point (INT8) based on the expressions (4) and (5). The SIMD arithmetic unit 11b calculates a tensor dst of FP32 as a sum-of-product arithmetic result by performing a SIMD arithmetic operation based on the expressions (2) and (3). The quantizer 11c calculates a tensor as a final result by quantizing the tensor dst of FP32 into a tensor of FP8. For example, quantization by the quantizer 11c can be performed by using a well-known technique such as calculating exponent portions and mantissa portions of all elements of the tensor, and performing stochastic rounding processing in calculating the mantissa portion.

SIMD Arithmetic Unit

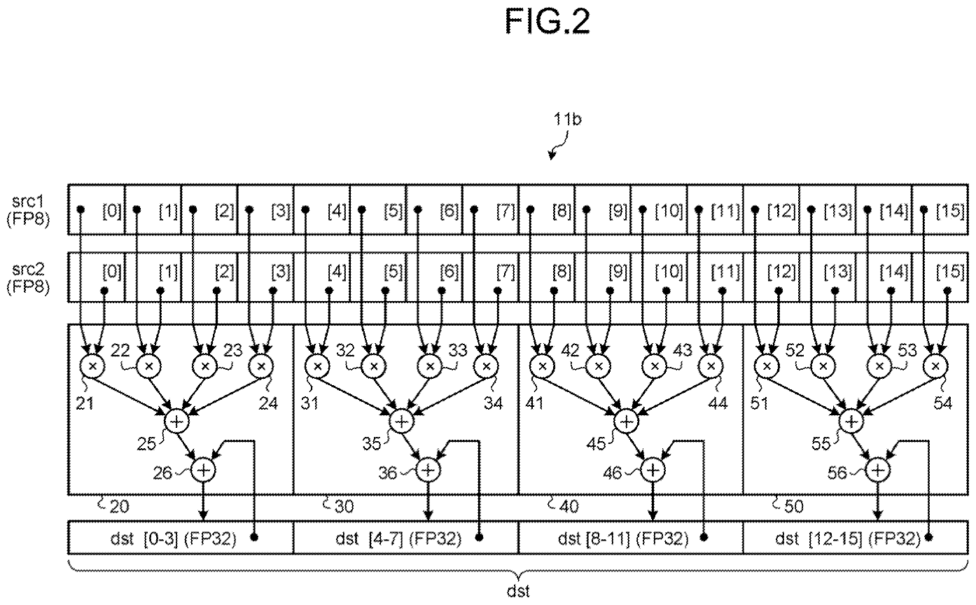

FIG. 2 is a diagram illustrating a configuration example of the SIMD arithmetic unit according to the first embodiment. In FIG. 2, the SIMD arithmetic unit 11b includes DOT4 arithmetic units 20, 30, 40, and 50. The DOT4 arithmetic unit 20 includes multipliers 21, 22, 23, and 24, and adders 25 and 26. The DOT4 arithmetic unit 30 includes multipliers 31, 32, 33, and 34, and adders 35 and 36. The DOT4 arithmetic unit 40 includes multipliers 41, 42, 43, and 44, and adders 45 and 46. The DOT4 arithmetic unit 50 includes multipliers 51, 52, 53, and 54, and adders 55 and 56. FIG. 2 exemplifies a case in which two pieces of data including input data src1 of 128 bits and input data src2 of 128 bits are respectively stored in two registers of 128 bits. The input data src1 is formed of 16 elements src1[0019] to [0020] each of which is FP8, and the input data src2 is formed of 16 elements src2[0021] to each of which is FP8.

In the DOT4 arithmetic unit 20, the multiplier 21 multiplies the element src1[0024] by the element src2[0025], the multiplier 22 multiplies the element src1[0026] by the element src2[0027], the multiplier 23 multiplies the element src1[0028] by the element src2[0029], and the multiplier 24 multiplies the element src1[0030] by the element src2[0031]. The adder 25 adds up a multiplication result obtained by the multiplier 21, a multiplication result obtained by the multiplier 22, a multiplication result obtained by the multiplier 23, and a multiplication result obtained by the multiplier 24. The adder 26 obtains an addition result at the present time by adding up an addition result obtained by the adder 25 and an addition result at a previous time obtained by the adder 26. The addition result at the present time obtained by the adder 26 is an arithmetic result dst[0-3] of FP32 as a sum-of-product arithmetic result of the elements src1[0032] to [0033] and the elements src2[0034] to [0035] obtained by the DOT4 arithmetic unit 20.

In the DOT4 arithmetic unit 30, the multiplier 31 multiplies the element src1[0037] by the element src2[0038], the multiplier 32 multiplies the element src1[0039] by the element src2[0040], the multiplier 33 multiplies the element src1[0041] by the element src2[0042], and the multiplier 34 multiplies the element src1[0043] by the element src2[0044]. The adder 35 adds up a multiplication result obtained by the multiplier 31, a multiplication result obtained by the multiplier 32, a multiplication result obtained by the multiplier 33, and a multiplication result obtained by the multiplier 34. The adder 36 obtains an addition result at the present time by adding up an addition result obtained by the adder 35 and an addition result at a previous time obtained by the adder 36. The addition result at the present time obtained by the adder 36 is an arithmetic result dst[4-7] of FP32 as a sum-of-product arithmetic result of the elements src1[0045] to [0046] and the elements src2[0047] to [0048] obtained by the DOT4 arithmetic unit 30.

In the DOT4 arithmetic unit 40, the multiplier 41 multiplies the element src1[0050] by the element src2[0051], the multiplier 42 multiplies the element src1[0052] by the element src2[0053], the multiplier 43 multiplies the element src1[0054] by the element src2[0055], and the multiplier 44 multiplies the element src1[0056] by the element src2[0057]. The adder 45 adds up a multiplication result obtained by the multiplier 41, a multiplication result obtained by the multiplier 42, a multiplication result obtained by the multiplier 43, and a multiplication result obtained by the multiplier 44. The adder 46 obtains an addition result at the present time by adding up an addition result obtained by the adder 45 and an addition result at a previous time obtained by the adder 46. The addition result at the present time obtained by the adder 46 is an arithmetic result dst[8-11] of FP32 as a sum-of-product arithmetic result of the elements src1[0058] to [0059] and the elements src2[0060] to [0061] obtained by the DOT4 arithmetic unit 40.

In the DOT4 arithmetic unit 50, the multiplier 51 multiplies the element src1[0063] by the element src2[0064], the multiplier 52 multiplies the element src1[0065] by the element src2[0066], the multiplier 53 multiplies the element src1[0067] by the element src2[0068], and the multiplier 54 multiplies the element src1[0069] by the element src2[0070]. The adder 55 adds up a multiplication result obtained by the multiplier 51, a multiplication result obtained by the multiplier 52, a multiplication result obtained by the multiplier 53, and a multiplication result obtained by the multiplier 54. The adder 56 obtains an addition result at the present time by adding up an addition result obtained by the adder 55 and an addition result at a previous time obtained by the adder 56. The addition result at the present time obtained by the adder 56 is an arithmetic result dst[12-15] of FP32 as a sum-of-product arithmetic result of the elements src1[0071] to [0072] and the elements src2[0073] to [0074] obtained by the DOT4 arithmetic unit 50.

In this way, in the SIMD arithmetic unit 11b, the DOT4 arithmetic unit 20 performs a sum-of-product arithmetic operation on the elements src1[0076] to [0077] and the elements src2[0078] to [0079], the DOT4 arithmetic unit 30 performs a sum-of-product arithmetic operation on the elements src1[0080] to [0081] and the elements src2[0082] to [0083], the DOT4 arithmetic unit 40 performs a sum-of-product arithmetic operation on the elements src1[0084] to [0085] and the elements src2 [0086] to [0087], and the DOT4 arithmetic unit 50 performs a sum-of-product arithmetic operation on the elements src1[0088] to [0089] and the elements src2[0090] to [0091]. That is, when the DOT4 arithmetic units 20, 30, 40, and 50 performs sum-of-product arithmetic operations of DOT4 corresponding to a dot product command for four elements, sum-of-product arithmetic operations corresponding to 16 elements are performed by the SIMD arithmetic unit 11b at the same time.

When the arithmetic result dst[0-3], the arithmetic result dst[4-7], the arithmetic result dst[8-11], and the arithmetic result dst[12-15], each of which is FP32, are coupled to each other, the arithmetic result dst is obtained by the SIMD arithmetic unit 11b.

In the example illustrated in FIG. 2, each element of the input data src1 and src2 is FP8, but the arithmetic result obtained by each of the DOT4 arithmetic units 20, 30, 40, and 50 is FP32. Thus, the number of simultaneous executions of a SIMD sum-of-product arithmetic operation in the SIMD arithmetic unit 11b is 16. The number of simultaneous executions of 16 is four times the number of simultaneous executions of a sum-of-product arithmetic operation in a case in which the input data is formed of four elements of FP32. That is, by performing a sum-of-product arithmetic operation on the input data of 128 bits (8 bits×16=128) each element of which is FP8 using the SIMD arithmetic unit 11b, the speed of the sum-of-product arithmetic operation can be increased by four times as compared with a case of performing a sum-of-product arithmetic operation on input data of 128 bits (32 bits×4=128) each element of which is FP32.

DOT4 Arithmetic Operation

In a case in which there are two vectors including a vector A represented by the expression (6) and a vector B represented by the expression (7), a dot product AB of the vector A and the vector B is given by the expression (8).

$$A = [ {a}_{1} , {a}_{2} , ⋯ , {a}_{n} ] \qquad ( 6 )$$

$$B = [ {b}_{1} , {b}_{2} , ⋯ , {b}_{n ]} \qquad ( 7 )$$

$$A \cdot B = {{\sum }_{i = 1}}^{n} {a}_{i} {b}_{i} = {a}_{1} {b}_{1} + {a}_{2} {b}_{2} + ⋯ + {a}_{n} {b}_{n} \qquad ( 8 )$$

A DOT4 command is a dot product of n=4, and is given by the expression (9).

$$dst = dst + {{\sum }_{i = 0}}^{3} src 1 [ i ] \cdot src 2 [ i ] \qquad ( 9 )$$

The following describes an example of a harmonic of the DOT4 command of FP8. In the following description, V_{dst} indicates a vector register of 32 bits per one element, and V_{dst} stores a result of the dot product. V_{src1,2} indicates a vector register of 8 bits per one element, and V_{src1,2} stores input data src1 and src2. X_{cfg} indicates a general-purpose register of 64 bits, and X_{cfg} stores the shared exponent bias value b of the input data src1 and src2.

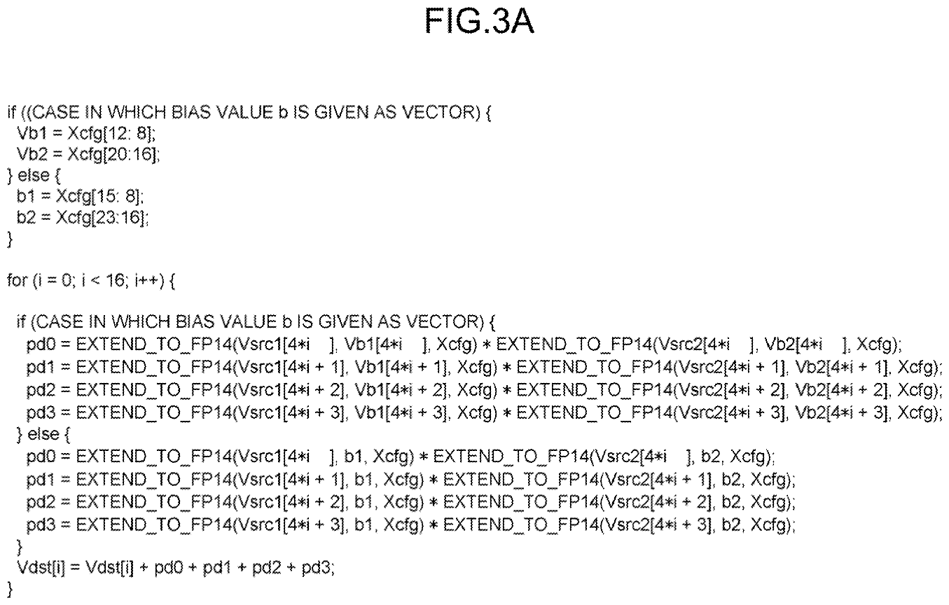

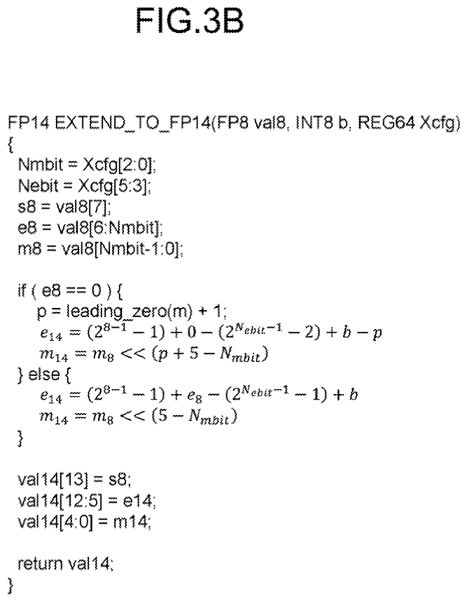

A pseudo-code of the DOT4 command is represented as illustrated in FIG. 3A and FIG. 3B by using V_{dst}, V_{src1,2}/and X_{cfg}. FIG. 3A and FIG. 3B are diagrams illustrating an example of the pseudo-code of the DOT4 command according to the first embodiment. FIG. 3B illustrates the pseudo-code continued from FIG. 3A. In FIG. 3A and FIG. 3B, considered is a case in which a vector length of the vector register is 512 bits, by way of example, so that data of 32 bits includes 16 elements, and data of 8 bits includes 64 elements. In FIG. 3B, leading_zero is a code for returning the number of times of continuation of 0 from the highest-order bit. For example, in a case of leading_zero=00100, 2 is returned.

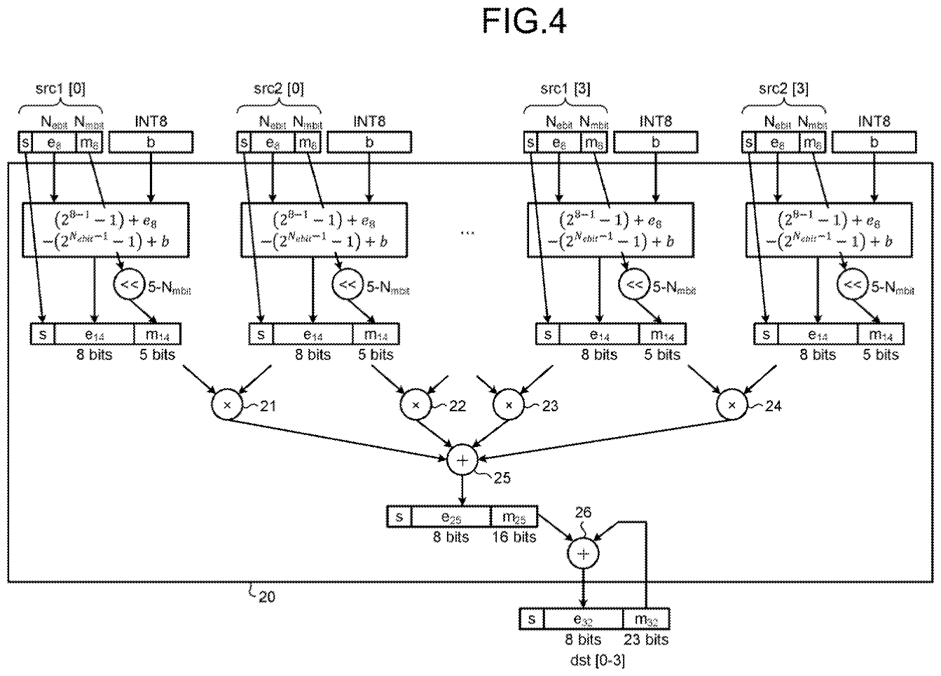

FIG. 4 is a diagram illustrating an example of an internal diagram of the DOT4 arithmetic unit according to the first embodiment. FIG. 4 illustrates an internal diagram of the DOT4 arithmetic unit 20 by way of example. FIG. 4 illustrates the internal diagram in a case in which the input data does not include denormalized data (a case of e₈>0).

In FIG. 4, each of the elements src1[0100] to [0101] of the input data src1 and the shared exponent bias values b of INT8 corresponding to each of the elements src1[0102] to [0103] are input as a set to the DOT4 arithmetic unit 20. At the same time, each of the elements src2[0104] to [0105] of the input data src2 and the shared exponent bias values b of INT8 corresponding to each of the elements src2[0106] to [0107] are input as a set to the DOT4 arithmetic unit 20. Each of the elements src1[0108] to [0109] and the elements src2[0110] to [0111] is formed of a sign bit S, N_{ebit} of e₈, and N_{mbit} of m₈.

In the DOT4 arithmetic unit 20 according to the first embodiment, a sum-of-product arithmetic operation based on the pseudo-code illustrated in FIG. 3A and FIG. 3B is performed as follows to calculate the arithmetic result dst[0-3] of FP32.

That is, the multiplier 21 multiplies data in which the sign bit S is added to a head of e₁₄ of 8 bits and m₁₄ of 5 bits, which is obtained by applying the expression (2) to e₈ and m₈ of the element src1[0114] and the shared exponent bias value b, by data in which the sign bit S is added to a head of e₁₄ of 8 bits and m₁₄ of 5 bits, which is obtained by applying the expression (2) to e₈ and m₈ of the element src2[0115] and the shared exponent bias value b.

The multiplier 22 multiplies data in which the sign bit S is added to a head of e₁₄ of 8 bits and m₁₄ of 5 bits, which is obtained by applying the expression (2) to e₈ and m₈ of the element src1[0117] and the shared exponent bias value b, by data in which the sign bit S is added to a head of e₁₄ of 8 bits and m₁₄ of 5 bits, which is obtained by applying the expression (2) to e₈ and m₈ of the element src2[0118] and the shared exponent bias value b.

The multiplier 23 multiplies data in which the sign bit S is added to a head of e₁₄ of 8 bits and m₁₄ of 5 bits, which is obtained by applying the expression (2) to e₈ and m₈ of the element src1[0120] and the shared exponent bias value b, by data in which the sign bit S is added to a head of e₁₄ of 8 bits and m₁₄ of 5 bits, which is obtained by applying the expression (2) to e₈ and m₈ of the element src2[0121] and the shared exponent bias value b.

The multiplier 24 multiplies data in which the sign bit S is added to a head of e₁₄ of 8 bits and m₁₄ of 5 bits, which is obtained by applying the expression (2) to e₈ and m₈ of the element src1[0123] and the shared exponent bias value b, by data in which the sign bit S is added to a head of e₁₄ of 8 bits and m₁₄ of 5 bits, which is obtained by applying the expression (2) to e₈ and m₈ of the element src2[0124] and the shared exponent bias value b.

The adder 25 adds up a multiplication result obtained by the multiplier 21, a multiplication result obtained by the multiplier 22, a multiplication result obtained by the multiplier 23, and a multiplication result obtained by the multiplier 24, and data in which the sign bit S is added to a head of e₂₅ of 8 bits and m₂₅ of 16 bits is obtained as an addition result.

The adder 26 adds up the addition result obtained by the adder 25 and the addition result at a previous time obtained by the adder 26, and data of FP32 in which the sign bit S is added to a head of e₃₂ of 8 bits and m₃₂ of 23 bits is obtained as an addition result at the present time. The addition result at the present time obtained by the adder 26 is the arithmetic result dst[0-3] of FP32 obtained by the DOT4 arithmetic unit 20.

Similarly to the DOT4 arithmetic unit 20, the DOT4 arithmetic unit 30 obtains the arithmetic result dst[4-7] of FP32 by performing a sum-of-product arithmetic operation on a data set of the elements src1[0128] to and the shared exponent bias value b, and a data set of the elements src2[0130] to [0131] and the shared exponent bias value b based on the pseudo-code illustrated in FIG. 3A and FIG. 3B.

Similarly to the DOT4 arithmetic unit 20, the DOT4 arithmetic unit 40 obtains the arithmetic result dst[8-11] of FP32 by performing a sum-of-product arithmetic operation on a data set of the elements src1[0133] to and the shared exponent bias value b, and a data set of the elements src2[0135] to [0136] and the shared exponent bias value b based on the pseudo-code illustrated in FIG. 3A and FIG. 3B.

Similarly to the DOT4 arithmetic unit 20, the DOT4 arithmetic unit 40 obtains the arithmetic result dst[12-15] of FP32 by performing a sum-of-product arithmetic operation on a data set of the elements src1[0138] to [0139] and the shared exponent bias value b, and a data set of the elements src2[0140] to [0141] and the shared exponent bias value b based on the pseudo-code illustrated in FIG. 3A and FIG. 3B.

That is, in the SIMD arithmetic unit 11b, sum-of-product arithmetic operations of DOT4 are performed on the data set of the elements src1[0143] to [0144] and the shared exponent bias value b, and the data set of the elements src2[0145] to [0146] and the shared exponent bias value b at the same time, and the arithmetic result dst is obtained by coupling the arithmetic results dst[0-3], [4-7], [8-11], and [12-15].

Processing Procedure Performed by Arithmetic Device

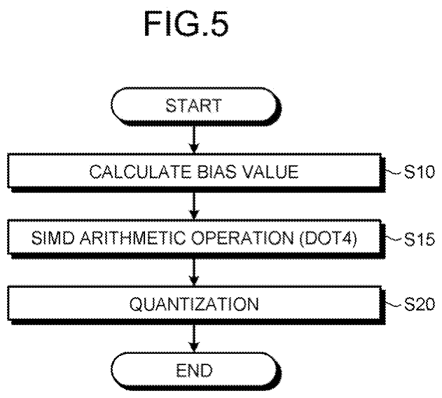

FIG. 5 is a flowchart illustrating an example of a processing procedure performed by the arithmetic device according to the first embodiment. In FIG. 5, at Step S10, the bias arithmetic unit 11a calculates the shared exponent bias value b. Subsequently, at Step S15, the SIMD arithmetic unit 11b performs a SIMD arithmetic operation using a sum-of-product arithmetic operation of DOT4. At Step S20, the quantizer 11c quantizes an arithmetic result of the SIMD arithmetic operation.

Data Flow in DNN Training Device

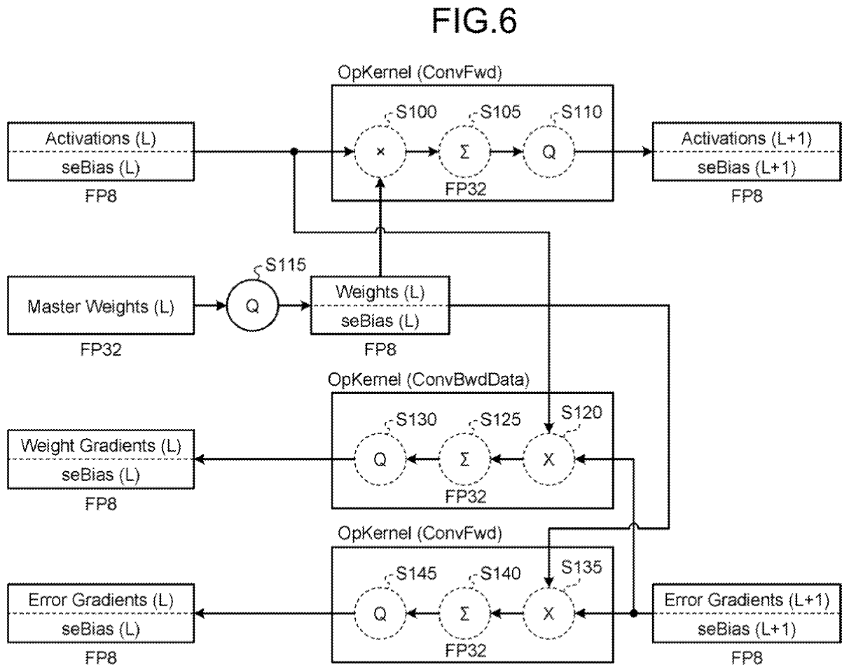

FIG. 6 is a diagram illustrating an example of a data flow in the DNN training device according to the first embodiment.

In FIG. 6, at Steps S100 and S105, sum-of-product arithmetic operations are performed on a data set of an activation value (L) of FP8 and a shared exponent bias value (L) of INT8, and a data set of a weight (L) of FP8 and a shared exponent bias value (L) of INT8. In the sum-of-product arithmetic operations performed at Steps S100 and S105, the activation value (L) corresponds to each of the elements src1[0150] to [0151] of FP8 of the input data src1 described above, and the weight (L) corresponds to each of the elements src2[0152] to [0153] of FP8 of the input data src2 described above. The shared exponent bias value (L) corresponds to the shared exponent bias value b described above, and is calculated by the bias arithmetic unit 11a. The sum-of-product arithmetic operation of DOT4 as described above is used as the sum-of-product arithmetic operation performed at Steps S100 and S105, and a sum-of-product arithmetic result of FP32 as a sum-of-product arithmetic result corresponding to four elements is obtained by the sum-of-product arithmetic operations performed at Steps S100 and S105. The sum-of-product arithmetic operation at Steps S100 and S105 is performed by the SIMD arithmetic unit 11b, and sum-of-product arithmetic operations corresponding to 16 elements (4 elements×4) are performed at the same time in the sum-of-product arithmetic operations at Steps S100 and S105.

At Step S110, quantization is performed to cause the sum-of-product arithmetic result of FP32 at Steps S100 and S105 to be FP8. Due to the quantization at Step S110, the activation value (L) is updated to be an activation value (L+1), and the shared exponent bias value (L) is updated to be a shared exponent bias value (L+1). The quantization at Step S110 is performed by the quantizer 11c.

At Step S115, a master weight (L) of FP32 is quantized to be FP8, and the weight (L) of FP8 is obtained accordingly. The quantization at Step S115 is performed by the quantizer 11c.

At Steps S120 and S125, sum-of-product arithmetic operations are performed on a data set of the activation value (L) of FP8 and the shared exponent bias value (L) of INT8, and a data set of an error gradient (L+1) of FP8 and the shared exponent bias value (L+1) of INT8. In the sum-of-product arithmetic operations performed at Steps S120 and S125, the activation value (L) corresponds to each of the elements src1[0157] to [0158] of FP8 of the input data src1 described above, and the error gradient (L+1) corresponds to each of the elements src2[0159] to [0160] of FP8 of the input data src2 described above. Each of the shared exponent bias values (L) and (L+1) corresponds to the shared exponent bias value b described above, and is calculated by the bias arithmetic unit 11a. The sum-of-product arithmetic operation of DOT4 as described above is used as the sum-of-product arithmetic operations at Steps S120 and S125. Due to the sum-of-product arithmetic operations at Steps S120 and S125, a sum-of-product arithmetic result of FP32 as a sum-of-product arithmetic result corresponding to four elements is obtained. The sum-of-product arithmetic operations at S120 and S125 are performed by the SIMD arithmetic unit 11b, and in the sum-of-product arithmetic operations at Steps S120 and S125, sum-of-product arithmetic operations corresponding to 16 elements (4 elements×4) are performed at the same time.

At Step S130, quantization is performed to cause the sum-of-product arithmetic result of FP32 at Steps S120 and S125 to be FP8. Due to the quantization at Step S130, the weight gradient (L) of FP8 and the shared exponent bias value (L) of INT8 are obtained. The quantization at Step S130 is performed by the quantizer 11c.

At Steps S135 and S140, sum-of-product arithmetic operations are performed on a data set of the weight (L) of FP8 and the shared exponent bias value (L) of INT8, and a data set of the error gradient (L+1) of FP8 and the shared exponent bias value (L+1) of INT8. In the sum-of-product arithmetic operations performed at Steps S135 and S140, the weight (L) corresponds to each of the elements src1[0163] to [0164] of FP8 of the input data src1 described above, and the error gradient (L+1) corresponds to each of the elements src2[0165] to [0166] of FP8 of the input data src2 described above. Each of the shared exponent bias values (L) and (L+1) corresponds to the shared exponent bias value b described above, and is calculated by the bias arithmetic unit 11a. The sum-of-product arithmetic operation of DOT4 as described above is used as the sum-of-product arithmetic operations at Steps S135 and S140. Due to the sum-of-product arithmetic operations at Steps S135 and S140, a sum-of-product arithmetic result of FP32 as a sum-of-product arithmetic result corresponding to four elements is obtained. The sum-of-product arithmetic operations at Steps S135 and S140 are performed by the SIMD arithmetic unit 11b, and in the sum-of-product arithmetic operations at Steps S135 and S140, sum-of-product arithmetic operations corresponding to 16 elements (4 elements×4) are performed at the same time.

At Step S145, quantization is performed to cause the sum-of-product arithmetic result of FP32 at Steps S135 and S140 to be FP8. Due to the quantization at Step S145, the error gradient (L+1) is updated to be an error gradient (L), and the shared exponent bias value (L+1) is updated to be the shared exponent bias value (L). The quantization at Step S145 is performed by the quantizer 11c.

Hardware Configuration of SIMD Arithmetic Unit

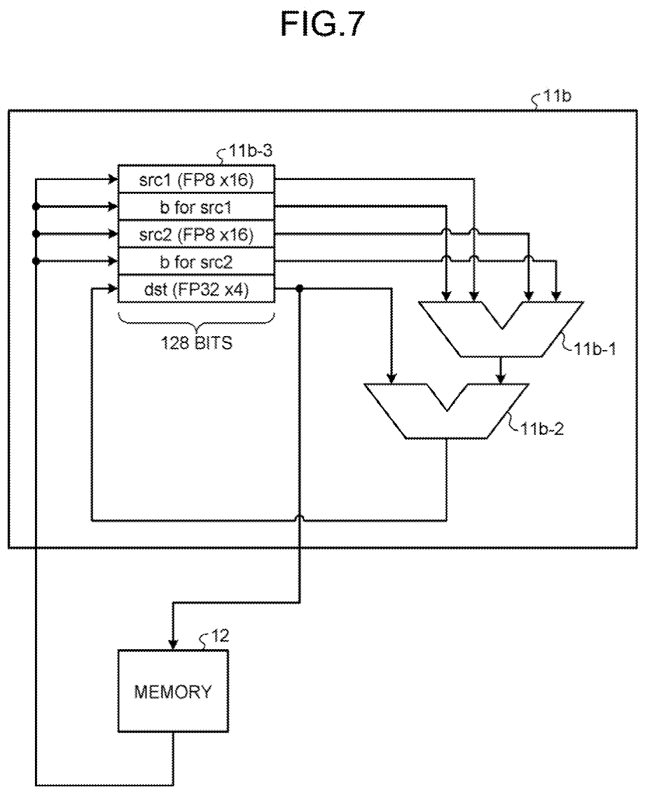

FIG. 7 is a diagram illustrating an example of a hardware configuration of the SIMD arithmetic unit according to the first embodiment. In FIG. 7, the SIMD arithmetic unit 11b includes a first operation unit 11b-1, a second operation unit 11b-2, and a register 11b-3.

The register 11b-3 is a register of 128 bits×5. The register 11b-3 stores 16 elements src1[0170] to [0171] each of which is FP8, 16 shared exponent bias values b of INT8 corresponding to the respective elements src1[0172] to [0173], 16 elements src2[0174] to [0175] each of which is FP8, 16 shared exponent bias values b of INT8 corresponding to the respective elements src2[0176] to [0177], and four sum-of-product arithmetic results dst[0-3], [4-7], [8-11], and [12-15] at a previous time each of which is FP32.

The elements src1[0179] to [0180], the shared exponent bias values b corresponding to the respective elements src1[0181] to [0182], the elements src2[0183] to [0184], and the shared exponent bias values b corresponding to the respective elements src2[0185] to [0186] are stored in the memory 12 in advance, and read out from the memory 12 to the register 11b-3.

The first operation unit 11b-1 performs addition and multiplication performed by the multipliers 21 to 24, the adder 25, the multipliers 31 to 34, the adder 35, the multipliers 41 to 44, the adder 45, the multipliers 51 to 54, and the adder 55 illustrated in FIG. 2. The second operation unit 11b-2 performs addition performed by the adders 26, 36, 46, and 56 illustrated in FIG. 2. Addition results at the present time obtained by the second operation unit 11b-2, that is, the four sum-of-product arithmetic results dst [0-3], [4-7], [8-11], and [12-15] at the present time, each of which is FP32, are stored in the memory 12.

The first embodiment has been described above.

### [b] Second Embodiment

The first embodiment has described a case in which the input data does not include denormalized data. On the other hand, the second embodiment is different from the first embodiment in that the input data includes denormalized data.

In a case in which the input data includes denormalized data, a value of FFPO to which the shared exponent bias value b is applied is given by the expression (10). That is, the expression (10) is an expression in a case in which the value is a denormalized number.

$$value = {( - 1 )}^{s} ( 0 + {{\sum }_{i = 1}}^{{N}_{mbit}} {m}_{- i} {2}^{- i} ) \times {2}^{0 - ( {2}^{N} {ebit}^{- 1} - 2 ) + b} \qquad ( 10 )$$

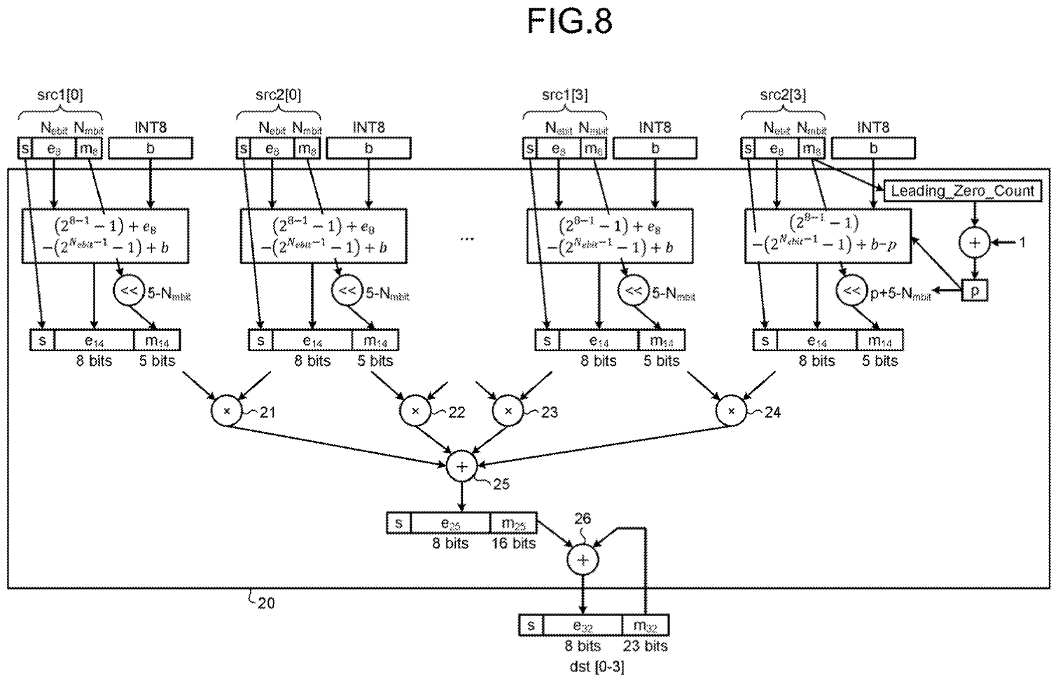

FIG. 8 is a diagram illustrating an example of an internal diagram of the DOT4 arithmetic unit according to the second embodiment. FIG. 8 illustrates an internal diagram of the DOT4 arithmetic unit 20 by way of example. FIG. 8 illustrates the internal diagram in a case in which the input data includes denormalized data (a case in which an element that satisfies e₈=0 is included in the input data). By way of example, only the element src[0192] is assumed to satisfy e₈=0 in FIG. 8. In FIG. 8, processing other than the processing performed by the multiplier 24 is the same as that in the first embodiment, so that description thereof will not be repeated.

The multiplier 24 multiplies data in which the sign bit S is added to a head of e₁₄ of 8 bits and m₁₄ of 5 bits, which is obtained by applying the expression (2) to e₈ and m₈ of the element src1[0194] and the shared exponent bias value b, by data in which the sign bit S is added to a head of e₁₄ of 8 bits and m₁₄ of 5 bits, which is obtained by applying the expression (10) to e₈ and m₈ of the element src2[0195] and the shared exponent bias value b.

The second embodiment has been described above.

According to the present disclosure, the speed of training of the DNN can be increased.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An arithmetic device comprising:
a first operation unit that calculates a shared exponent bias value for shifting a dynamic range of a floating-point operation;
a second operation unit that calculates a sum-of-product arithmetic result of a second number of bits larger than a first number of bits by performing sum-of-product arithmetic operations corresponding to a large number of elements on a first data set formed of a shared exponent bias value and an activation value of a floating point of the first number of bits, and a second data set formed of a shared exponent bias value and a weight of a floating point of the first number of bits; and
a quantizer that updates the activation value by quantizing the number of bits of the sum-of-product arithmetic result from the second number of bits to the first number of bits.

2. The arithmetic device according to claim 1, wherein the activation value includes denormalized data.

3. The arithmetic device according to claim 1, wherein the sum-of-product arithmetic operations corresponding to the large number of elements are dot product arithmetic operations corresponding to four elements.
